(19) United States
(12) Patent Application Publication
(10) Pub. No.: US 2007/0297031 A1
(43) Pub. Date: Dec. 27, 2007

(54) Optical pickup device

(76) Inventors: Masahiko Nishimoto, Osaka (JP); Naoki Nakanishi, Shiga (JP); Masayuki Ono, Osaka (JP); Yasuyuki Kochi, Osaka (JP)

Correspondence Address: MCDERMOTT WILL & EMERY LLP, 600 13TH STREET, NW, WASHINGTON, DC, 20005-3096, US

(21) Appl. No.: 11/709,132

(22) Filed: Feb. 22, 2007

(30) Foreign Application Priority Data
Jun. 22, 2006 (JP) 2006-172918

(51) Int. Cl. G02B 5/32

(52) U.S. Cl. 359/15

(57) ABSTRACT

An optical pickup device includes a first semiconductor laser device, a second semiconductor laser device, a third semiconductor laser device, a first diffraction grating, a beam splitter, a quarter-wave plate, a collimator lens, a first polarization hologram device, a second polarization hologram device and a third polarization hologram device. The second semiconductor laser device and the third semiconductor laser device are provided in a light source/detection unit together with a second diffraction grating and photo-receiver groups, so as to make the optical pickup device compact.

### BACKGROUND OF THE INVENTION

The present invention relates to an optical pickup device used for recording/reproducing information in/from an optical information recording medium.

Recently, technical standards of various optical information recording media such as a CD, a DVD, a Blu-ray disc and an HD DVD have been developed and put to practical use, and there are increasing demands for a device singly capable of performing a recording/reproducing operation on all the various recording media regardless of their standards (see Japanese Laid-Open Patent Publication No. 2004-103135).

FIG. 19 is a top view for showing the architecture of a conventional optical pickup device. As shown in FIG. 19, the conventional optical pickup device 12 includes light source/detection units 1, 3 and 5, collimator lenses 2, 4 and 6, beam splitters 7 and 9, an aberration correcting device 8, a deflecting mirror 10 and an object lens 11. The light source/detection unit 1 and the collimator lens 2 deal with a short wavelength and are used for a Blu-ray Disc or an HD DVD. Also, the light source/detection unit 3 and the collimator lens 4 deal with a middle wavelength and are used for a DVD. The light source/detection unit 5 and the collimator lens 6 deal with a long wavelength and are used for a CD.

### SUMMARY OF THE INVENTION

The conventional optical pickup device 12 has, however, a problem of a large number of components because the light source/detection units and the collimator lens are provided correspondingly to the respective wavelengths. Therefore, the cost is high and high assembling accuracy is required.

For overcoming this problem, an optical pickup device in which the number of, for example, light source/detection units is reduced to two has been proposed (see Japanese Laid-Open Patent Publication No. 2001-184705). In this architecture, however, a hologram device is separately provided and two photo-receivers are used. Therefore, the cost cannot be sufficiently reduced, and high assembling accuracy is still necessary.

The present invention was devised to overcome the above-described conventional problem, and an object is providing an optical pickup device that is capable of performing a recording/reproducing operation on various optical information recording media, includes a reduced number of components, is compact and has an architecture easily assembled.

In order to achieve the object, the optical pickup device of the invention includes a first semiconductor laser device for emitting a first light beam; a second semiconductor laser device for emitting a second light beam; a third semiconductor laser device for emitting a third light beam; a collimator lens for collimating the first light beam, the second light beam and the third light beam; a beam splitter for reflecting or transmitting the first light beam, the second light beam and the third light beam and collecting the first light beam, the second light beam and the third light beam on the collimator lens; a first hologram device for diffracting, into ±first-order diffracted light, the first light beam having been reflected on a recording surface of an optical information recording medium and having passed through the beam splitter; a second hologram device for diffracting, into ±first-order diffracted light, the second light beam having been reflected on the recording surface of the optical information recording medium and having passed through the beam splitter; a third hologram device for diffracting, into ±first-order diffracted light, the third light beam having been reflected on the recording surface of the optical information recording medium and having passed through the beam splitter; and a plurality of photo-receiver groups for receiving the ±first-order diffracted light having been diffracted by the first hologram device, the second hologram device and the third hologram device, and the second semiconductor laser device, the third semiconductor laser device and the plurality of photo-receiver groups are provided in one light source/detection unit.

The optical pickup device having the aforementioned architecture includes the three semiconductor laser devices, and the second semiconductor laser device, the third semiconductor laser device and the plural photo-receiver groups are provided in one light source/detection unit. Therefore, as compared with a conventional optical pickup device including light source/detection units correspondingly to wavelengths to be processed, the number of components can be reduced. Also, since the collimator lens, the beam splitter and the plural photo-receiver groups are commonly used regardless of the kind of light beams, the number of components can be further reduced. As a result, a compact optical pickup device that is capable of coping with the standards of three kinds of optical information recording media and is easily assembled can be realized.

The optical pickup device of the invention preferably further includes a first diffraction grating, for diffracting the first light beam into a main beam and a sub beam, provided on an optical path of the first light beam extending from the first semiconductor laser device to the beam splitter.

The optical pickup device of the invention preferably further includes a second diffraction grating, for diffracting each of the second light beam and the third light beam into a main beam and a sub beam, provided on an optical path of the second light beam extending from the second semiconductor laser device to the beam splitter and on an optical path of the third light beam extending from the third semiconductor laser device to the beam splitter. In this case, the second diffraction grating is preferably provided on the light source/detection unit to be positioned above the second semiconductor laser device and the third semiconductor laser device. Thus, the light source/detection unit and the second diffraction grating are integrated with each other, and hence, the optical pickup device of the invention can be easily assembled.

In the optical pickup device of the invention, the first hologram device, the second hologram device and the third hologram device are preferably provided between the beam splitter and the second diffraction grating. In this case, the first hologram device, the second hologram device and the third hologram device are preferably integrated with one another, and more preferably, the first hologram device, the second hologram device, the third hologram device and the second diffraction grating are integrated with the light source/detection unit.

Thus, the assembling accuracy of the optical pickup device can be improved as compared with the case where these components are individually provided. As a result, a compact and easily assembled optical pickup device can be realized.

Furthermore, in the optical pickup device of this invention, the first light beam emitted by the first semiconductor laser device can be collected on the optical information recording medium without passing through a polarization hologram device. Therefore, energy loss of the laser beam otherwise caused in passing through a polarization hologram device can be suppressed, so as to realize an optical pickup device with high optical utilization.

Moreover, it is preferred that the first light beam has a wavelength of a 405 nm band, that the second light beam has a wavelength of a 650 nm band and that the third light beam has a wavelength of a 780 nm band. Thus, the optical pickup device of this invention can record/reproduce information in/from a Blu-ray disc, a DVD and a CD.

In the optical pickup device of the invention, a principal ray of the first light beam and a principal ray of the second light beam preferably substantially accord with an optical axis of the collimator lens on the collimator lens. Thus, each of the first light beam and the second light beam enters an object lens in an optimum position at an optimum angle, and therefore, the quality of a beam spot shape obtained on the optical information recording medium can be improved. As a result, information can be accurately recorded/reproduced in/from each optical information recording medium having the standard corresponding to the first light beam or the second light beam. Thus, a high performance optical pickup device in accordance with the standards of various optical information recording media can be realized.

The second semiconductor laser device and the third semiconductor laser device are preferably integrated with each other as a monolithic dual-wavelength semiconductor laser device, and thus, the number of components can be further reduced.

In the optical pickup device of the invention, each of the first hologram device, the second hologram device and the third hologram device is preferably a polarization hologram device.

Alternatively, each of the first hologram device and the second hologram device is preferably a polarization hologram device, and the third hologram device is preferably a non-polarization hologram device. Thus, even when an optical information recording medium corresponding to the wavelength of the third light beam has poor quality, the optical pickup device can stably perform a write operation.

The optical pickup device of the invention preferably further includes a quarter-wave plate disposed between the beam splitter and the collimator lens.

The optical pickup device of the invention preferably further includes an operating section for detecting each electric signal output from the plurality of photo-receiver groups and generating a focus error signal or a tracking error signal based on the detected electric signal.

### BRIEF DESCRIPTION OF THE DRAWINGS

FIG. 1 is a cross-sectional view for showing the architecture of an optical pickup device according to Embodiment 1 of the invention;

FIG. 2 is a cross-sectional view for showing the optical path of first outgoing light in the optical pickup device of Embodiment 1;

FIG. 3 is a cross-sectional view for showing the optical path of second outgoing light in the optical pickup device of Embodiment 1;

FIG. 4 is a cross-sectional view for showing the optical path of third outgoing light in the optical pickup device of Embodiment 1;

FIG. 5 is a top view of a first polarization hologram device used in the optical pickup device of Embodiment 1;

FIG. 6 is a top view of a second polarization hologram device used in the optical pickup device of Embodiment 1;

FIG. 7 is a top view of a third polarization hologram device used in the optical pickup device of Embodiment 1;

FIG. 8 is a top view for showing arrangement of photo-receiver groups used in the optical pickup device of Embodiment 1;

FIG. 9 is a top view for showing diffraction spots of the first outgoing light in the optical pickup device of Embodiment 1;

FIG. 10 is a top view for showing diffraction spots of the second outgoing light in the optical pickup device of Embodiment 1;

FIG. 11 is a top view for showing diffraction spots of the third outgoing light in the optical pickup device of Embodiment 1;

FIG. 12 is a cross-sectional view for showing the architecture of an optical pickup device according to Embodiment 2 of the invention;

FIG. 13 is a cross-sectional view for showing the optical path of first outgoing light in the optical pickup device of Embodiment 2;

FIG. 14 is a cross-sectional view for showing the optical path of second outgoing light in the optical pickup device of Embodiment 2;

FIG. 15 is a cross-sectional view for showing the optical path of third outgoing light in the optical pickup device of Embodiment 2;

FIG. 16 is a cross-sectional view for showing the architecture of an optical pickup device according to Embodiment 3 of the invention;

FIG. 17 is a cross-sectional view for showing the architecture of an optical pickup device according to Embodiment 4 of the invention;

FIG. 18 is a cross-sectional view for showing the architecture of an optical pickup device according to Embodiment 5 of the invention; and

FIG. 19 is a top view for showing the architecture of a conventional optical pickup device.

### DETAILED DESCRIPTION OF THE INVENTION

### Embodiment 1

The architecture and the operation of an optical pickup device according to Embodiment 1 of the invention will now be described with reference to the accompanying drawings. Herein, a main beam means zero-order diffracted light and a sub beam means ±first-order diffracted light.

—Architecture of Optical Pickup Device—

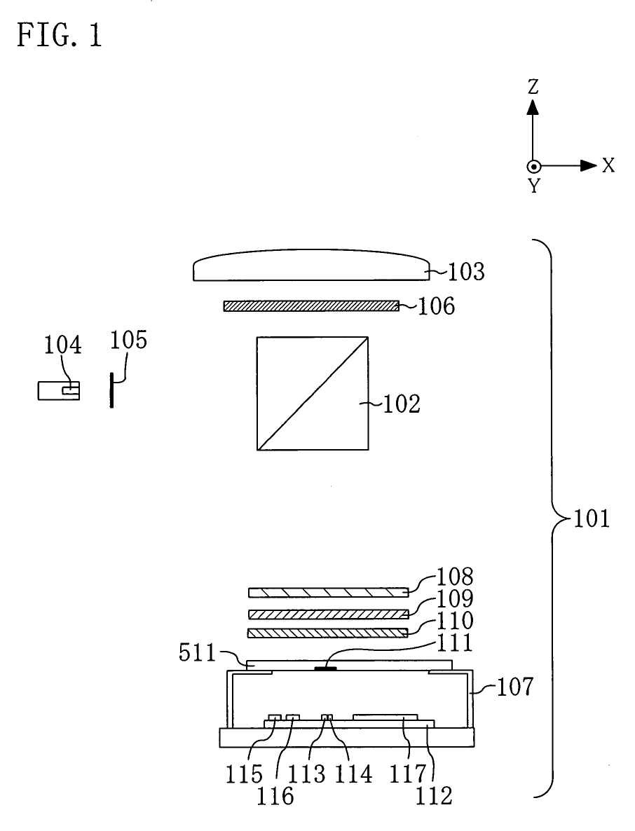

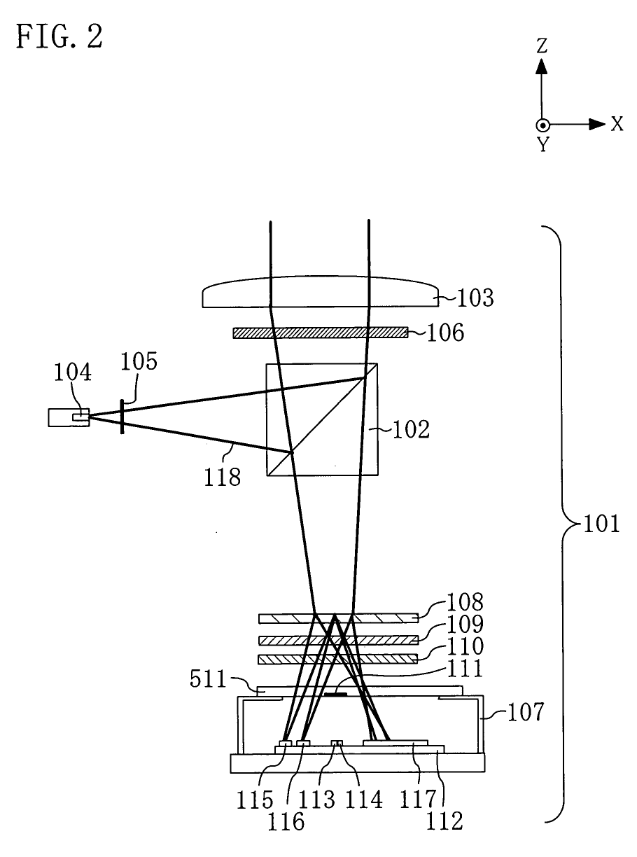

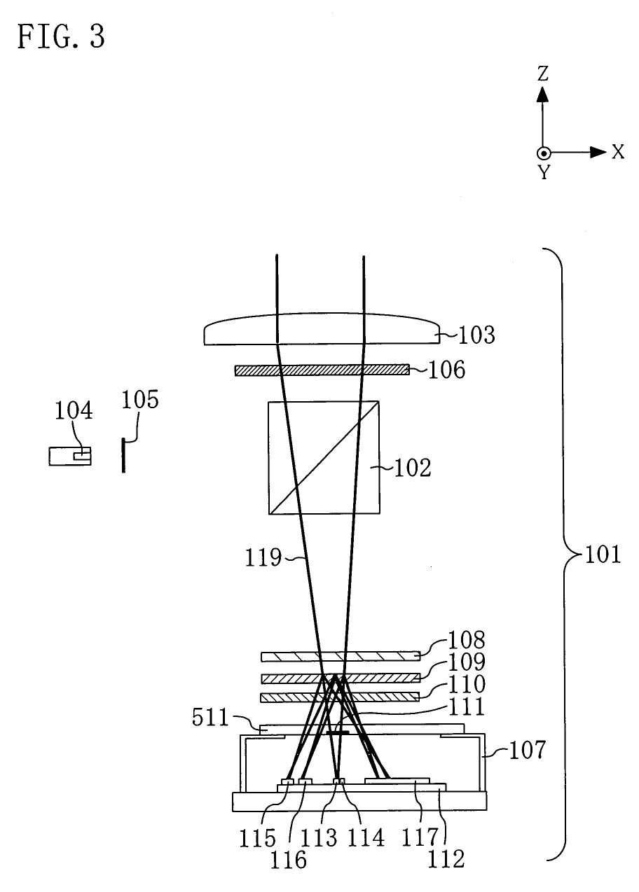

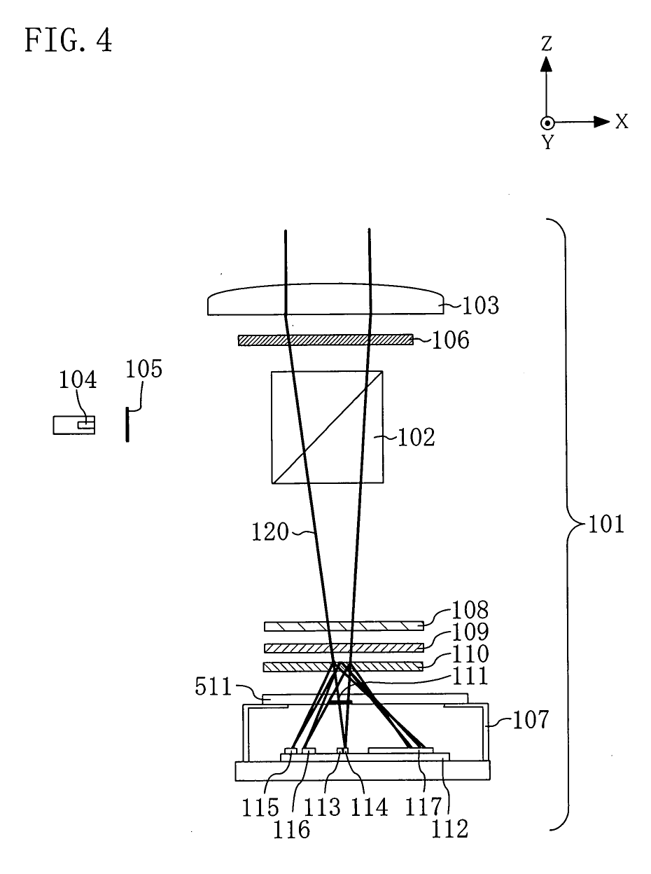

FIG. 1 is a cross-sectional view for showing the architecture of the optical pickup device according to Embodiment 1 of the invention. As shown in FIG. 1, the optical pickup device of this embodiment includes three semiconductor laser devices for coping with three kinds of optical information recording media. A first semiconductor laser device 104 emits a laser beam (light beam) of a 405 nm band in accordance with the Blu-ray disc standard. Also, a second semiconductor laser device 113 emits a laser beam (light beam) of a 650 nm band in accordance with the DVD standard, and a third semiconductor laser device 114 emits a laser beam (light beam) of a 780 nm band in accordance with the CD standard. In this embodiment, the laser beam of the 405 nm band emitted by the first semiconductor laser device 104 is designated as first outgoing light 118 (shown in FIG. 2). Similarly, the laser beam of the 650 nm band emitted by the second semiconductor laser device 113 is designated as second outgoing light 119 (shown in FIG. 3) and the laser beam of the 780 nm band emitted by the third semiconductor laser device 114 is designated as third outgoing light 120 (shown in FIG. 4).

The optical pickup device 101 of this embodiment includes the first semiconductor laser device 104, a first diffraction grating 105, a beam splitter 102, a quarter-wave plate 106, a collimator lens 103, a light source/detection unit 107, and a first polarization hologram device 108, a second polarization hologram device 109 and a third polarization hologram device 110 arranged between the light source/detection unit 107 and the beam splitter 102 in this order from a side of the beam splitter 102. The first diffraction grating 105 is disposed between the first semiconductor laser device 104 and the beam splitter 102. Also, the quarter-wave plate 106 is disposed between the beam splitter 102 and the collimator lens 103.

The light source/detection unit 107 includes an integrated substrate 112, the second semiconductor laser device 113, the third semiconductor laser device 114, a first photo-receiver group 115, a second photo-receiver group 116, a third photo-receiver group 117 and a second diffraction grating 111. The second diffraction grating 111 is formed on the lower face of a transparent member 511 made of a glass plate or the like so as to be positioned above the second semiconductor laser device 113 and the third semiconductor laser device 114.

The first semiconductor laser device 104 is disposed so that the principal ray of the first outgoing light 118 can be perpendicular to the optical axis of the collimator lens 103. The first outgoing light 118 enters the beam splitter 102 after passing through the first diffraction grating 105. The first outgoing light 118 is reflected by the beam splitter 102 and the reflected light is guided to the collimator lens 103.

On the other hand, the second outgoing light 119 and the third outgoing light 120 pass through the beam splitter 102. Also, reflected light from an optical information recording medium passes through the beam splitter 102 and is guided to the first polarization hologram device 108, the second polarization hologram device 109 and the third polarization hologram device 110.

The first polarization hologram device 108 is designed to diffract the first outgoing light 118 and to transmit the second outgoing light 119 and the third outgoing light 120. Similarly, the second polarization hologram device 109 diffracts the second outgoing light 119 alone, and the third polarization hologram device 110 diffracts the third outgoing light 120 alone.

—Operation of Optical Pickup Device—

The operation of the optical pickup device 101 of this embodiment will now be described with reference to FIGS. 2 through 11. In the optical pickup device 101 of this embodiment, after discriminating the standard of a loaded optical information recording medium, one of the semiconductor laser devices corresponding to the standard of the optical information recording medium is used for irradiating the optical information recording medium with the laser beams.

First, the use of the first semiconductor laser device 104 for emitting the laser beam of the 405 nm band in accordance with the Blu-ray disc standard will be described. FIG. 2 is a cross-sectional view of the optical path of the first outgoing light 118 in the optical pickup device of this embodiment.

As shown in FIG. 2, the first outgoing light 118 is diffracted by the first diffraction grating 105 into a main beam and a sub beam. The diffracted first outgoing light 118 is reflected by the beam splitter 102, passes through the quarter-wave plate 106 and is collimated by the collimator lens 103. Thereafter, the first outgoing light 118 is collected by an object lens (not shown) onto a recording surface of the optical information recording medium. The first outgoing light 118 having been reflected on the recording surface passes through the beam splitter 102 and enters the first polarization hologram device 108. Then, the first outgoing light 118 is diffracted by the first polarization hologram device 108 into ±first-order diffracted light and passes through the second polarization hologram device 109 and the third polarization hologram device 110. Thereafter, the first outgoing light 118 enters the first photo-receiver group 115, the second photo-receiver group 116 and the third photo-receiver group 117.

Next, the use of the second semiconductor laser device 113 for emitting the laser beams of the 650 nm band in accordance with the DVD standard will be described. FIG. 3 is a cross-sectional view of the optical path of the second outgoing light 119 in the optical pickup device of this embodiment.

As shown in FIG. 3, the second outgoing light 119 is diffracted by the second diffraction grating 111 into a main beam and a sub beam. The diffracted second outgoing light 119 passes through the beam splitter 102, passes through the quarter-wave plate 106 and is collimated by the collimator lens 103. Thereafter, the second outgoing light 119 is collected by an object lens (not shown) onto a recording surface of the optical information recording medium. The second outgoing light 119 having been reflected on the recording surface passes through the beam splitter 102 through the same optical path as the outward path, passes through the first polarization hologram device 108 and enters the second polarization hologram device 109. Then, the second outgoing light 119 is diffracted by the second polarization hologram device 109 into ±first-order diffracted light and passes through the third polarization hologram device 110. Thereafter, the second outgoing light 119 enters the first photo-receiver group 115, the second photo-receiver group 116 and the third photo-receiver group 117.

Furthermore, the use of the third semiconductor laser device 114 for emitting the laser beams of the 780 nm band in accordance with the CD standard will be described. FIG. 4 is a cross-sectional view of the optical path of the third outgoing light 120 in the optical pickup device of this embodiment.

As shown in FIG. 4, the third outgoing light 120 is diffracted by the second diffraction grating 111 into a main beam and a sub beam in the same manner as the second outgoing light 119. The diffracted third outgoing light 120 successively passes through the beam splitter 102 and the quarter-wave plate 106 and is collimated by the collimator lens 103. Thereafter, the third outgoing light 120 is collected by an object lens (not shown) onto a recording surface of the optical information recording medium. The third outgoing light 120 having been reflected on the recording surface passes through the beam splitter 102 through the same optical path as the outward path, passes through the first polarization hologram device 108 and the second polarization hologram device 109 and enters the third polarization hologram device 110. Then, the third outgoing light 120 is diffracted by the third polarization hologram device 110 into ±first-order diffracted light and enters the first photo-receiver group 115, the second photo-receiver group 116 and the third photo-receiver group 117.

In this manner, the outgoing light of each semiconductor laser device is reflected on the recording surface of the optical information recording medium, is diffracted by the corresponding polarization hologram device into the ±first-order diffracted light, and enters the respective photo-receiver groups. Now, the operation in which the outgoing light of each semiconductor laser device composed of the main beam and the sub beam is diffracted by the polarization hologram device corresponding to the wavelength of the laser beam and is guided to the respective photo-receiver groups will be described in detail.

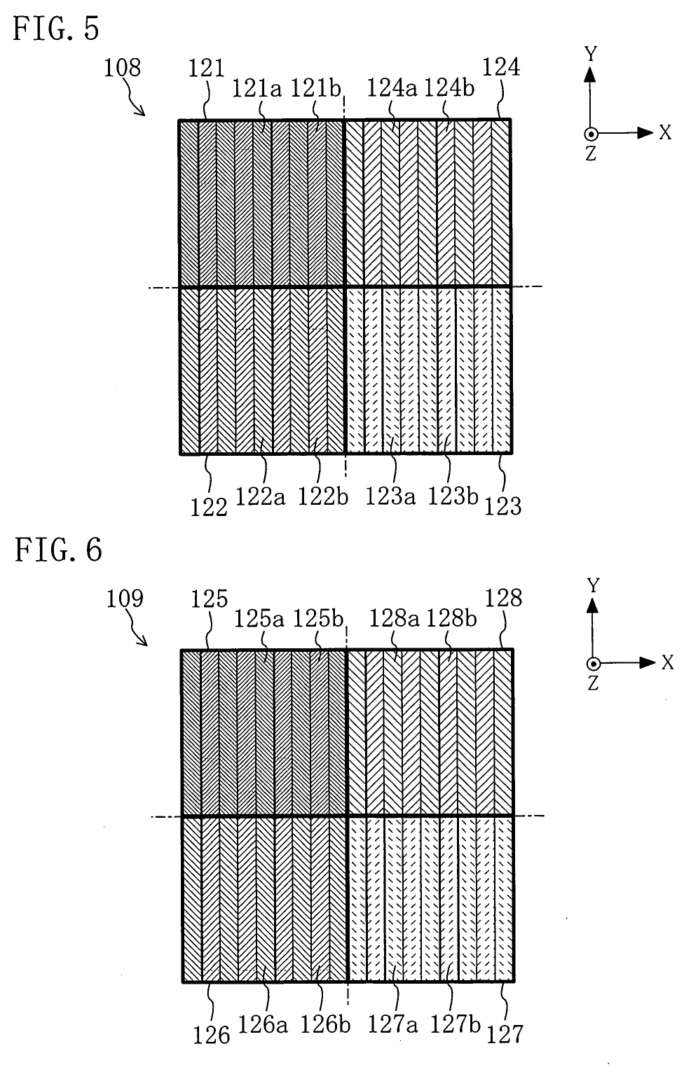

First, the first outgoing light 118 diffracted by the first polarization hologram device 108 will be described. FIG. 5 is a top view of the first polarization hologram device 108 used in the optical pickup device of this embodiment.

As shown in FIG. 5, the first polarization hologram device 108 is divided into a first region 121, a second region 122, a third region 123 and a fourth region 124. Each of the divided regions is further divided into strip-shaped regions. In the first region 121, first strip-shaped regions 121a and 121b are alternately arranged. Similarly, in the second region 122, second strip-shaped regions 122a and 122b are alternately arranged, in the third region 123, third strip-shaped regions 123a and 123b are alternately arranged, and in the fourth region 124, fourth strip-shaped regions 124a and 124b are alternately arranged. It is noted that the center of the first polarization hologram device 108 substantially overlaps the optical axis of the collimator lens 103 in a plan view.

The first outgoing light 118 having been reflected on the surface of the optical information recording medium is diffracted along the X-direction of FIG. 5 in the first region 121 of the first polarization hologram device 108, so that the ±first-order diffracted light can be guided to the first photo-receiver group 115 and the third photo-receiver group 117. Similarly, the ±first-order diffracted light diffracted along the X-direction in the second region 122 is guided to the first photo-receiver group 115 and the third photo-receiver group 117. Also, the ±first-order diffracted light diffracted along the X-direction in the third region 123 is guided to the second photo-receiver group 116 and the third photo-receiver group 117. Furthermore, the ±first-order diffracted light diffracted along the X-direction in the fourth region 124 is guided to the second photo-receiver group 116 and the third photo-receiver group 117.

Next, the second outgoing light 119 diffracted by the second polarization hologram device 109 will be described. FIG. 6 is a top view of the second polarization hologram device 109 used in the optical pickup device of this embodiment.

As shown in FIG. 6, the second polarization hologram device 109 is divided into four regions of a fifth region 125, a sixth region 126, a seventh region 127 and an eighth region 128 in the same manner as the first polarization hologram device 108. Each of the divided regions is further divided into strip-shaped regions. Fifth strip-shaped regions 125a and 125b are alternately arranged in the fifth region 125, sixth strip-shaped regions 126a and 126b are alternately arranged in the sixth region 126, seventh strip-shaped regions 127a and 127b are alternately arranged in the seventh region 127, and eighth strip-shaped regions 128a and 128b are alternately arranged in the eighth region 128. It is noted that the center of the second polarization hologram device 109 substantially overlaps the optical axis of the collimator lens 103 in a plan view.

The second outgoing light 119 having been reflected on the surface of the optical information recording medium is diffracted along the X-direction of FIG. 6 in the fifth region 125 of the second polarization hologram device 109, so that the ±first-order diffracted light can be guided to the first photo-receiver group 115 and the third photo-receiver group 117. Similarly, the ±first-order diffracted light diffracted along the X-direction in the sixth region 126 is guided to the first photo-receiver group 115 and the third photo-receiver group 117. Also, the ±first-order diffracted light diffracted along the X-direction in the seventh region 127 is guided to the second photo-receiver group 116 and the third photo-receiver group 117. Furthermore, the ±first-order diffracted light diffracted along the X-direction in the eighth region 128 is guided to the second photo-receiver group 116 and the third photo-receiver group 117.

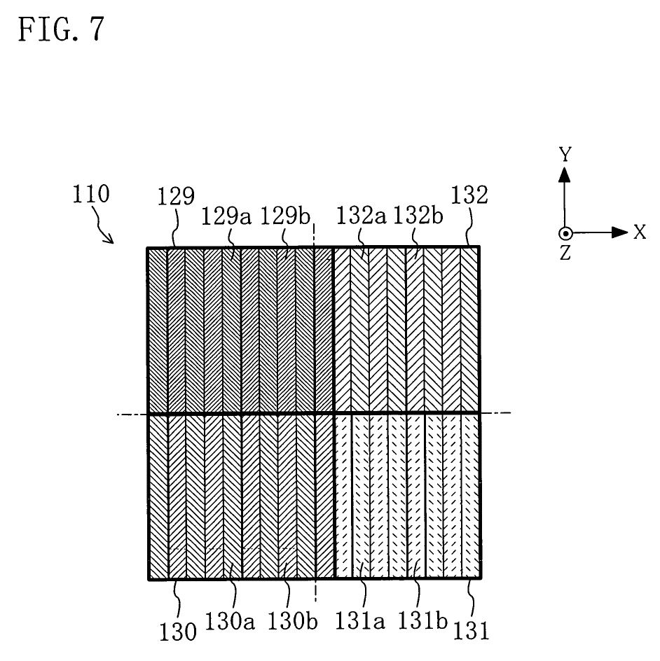

Furthermore, the third outgoing light 120 diffracted by the third polarization hologram device 110 will be described. FIG. 7 is a top view of the third polarization hologram device 110 used in the optical pickup device of this embodiment.

As shown in FIG. 7, the third polarization hologram device 110 is divided into four regions of a ninth region 129, a tenth region 130, an eleventh region 131 and a twelfth region 132 in the same manner as the first polarization hologram device 108. Each of the divided regions is further divided into strip-shaped regions. Ninth strip-shaped regions 129a and 129b are alternately arranged in the ninth region 129. Similarly, tenth strip-shaped regions 130a and 130b are alternately arranged in the tenth region 130, eleventh strip-shaped regions 131a and 131b are alternately arranged in the eleventh region 131, and twelfth strip-shaped regions 132a and 132b are alternately arranged in the twelfth region 132. It is noted that crossing points of boundaries of the four regions of the third polarization hologram device 110 substantially overlap the optical axis of the third semiconductor laser device 114 in a plan view.

The third outgoing light 120 having been reflected on the surface of the optical information recording medium is diffracted along the X-direction of FIG. 7 in the ninth region 129, so that the ±first-order diffracted light can be guided to the first photo-receiver group 115 and the third photo-receiver group 117. Similarly, the ±first-order diffracted light diffracted along the X-direction in the tenth region 130 is guided to the first photo-receiver group 115 and the third photo-receiver group 117. Also, the ±first-order diffracted light diffracted along the X-direction in the eleventh region 131 is guided to the second photo-receiver group 116 and the third photo-receiver group 117. Furthermore, the ±first-order diffracted light diffracted along the X-direction in the twelfth region 132 is guided to the second photo-receiver group 116 and the third photo-receiver group 117.

In this manner, the outgoing light of each semiconductor laser device composed of the main beam and the sub beam is diffracted into the ±first-order diffracted light in each region of the corresponding polarization hologram device so as to enter the photo-receiver groups. At this point, a tracking error signal is detected from the main beam and the sub beam of the semiconductor laser device collected onto the first photo-receiver group 115 and the second photo-receiver group 116. On the other hand, a focus error signal is detected from the main beam of the semiconductor laser device collected onto the third photo-receiver group 117. When a tracking error signal or a focus error signal is detected, focus adjustment or tracking adjustment is automatically performed, so that information can be read/written from/in the optical information recording medium.

Subsequently, methods for detecting the aforementioned focus error signal and tracking error signal will be described in detail.

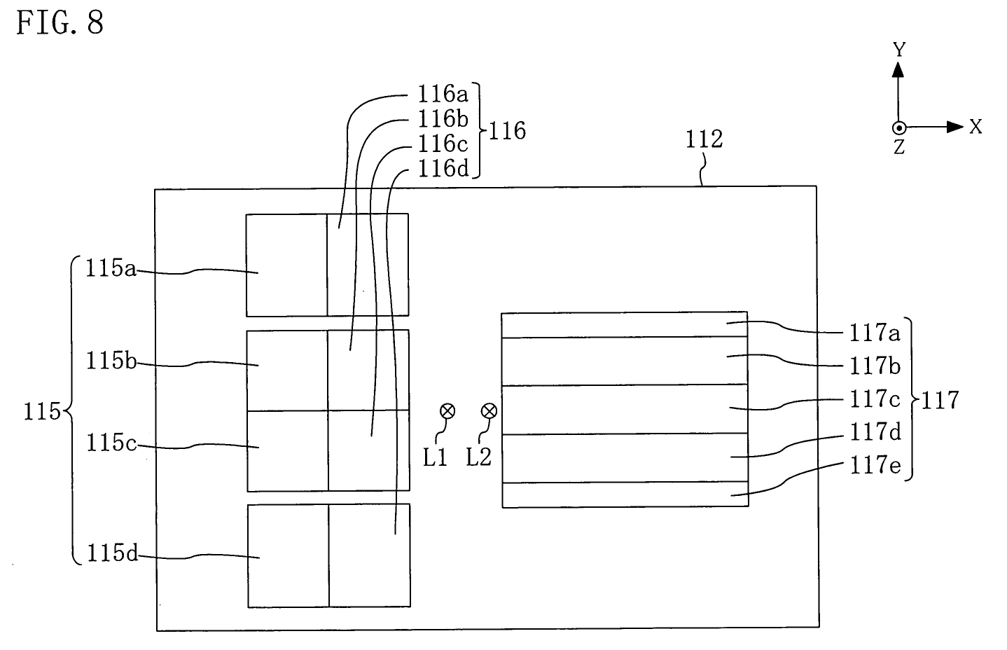

First, diffraction spots of the ±first-order diffracted light entering the respective photo-receiver groups will be described with reference to FIGS. 8 through 11. FIG. 8 is a top view for showing the arrangement of the photo-receiver groups in the optical pickup device of this embodiment.

As shown in FIG. 8, each of the first photo-receiver group 115, the second photo-receiver group 116 and the third photo-receiver group 117 provided on the integrated substrate 112 is divided into a plurality of photo-receiver regions along the Y-axis direction. The first photo-receiver group 115 is divided into four regions of first photo-receiver regions 115a, 115b, 115c and 115d along the Y-axis direction. The second photo-receiver group 116 is divided into four regions of second photo-receiver regions 116a, 116b, 116c and 116d along the Y-axis direction. The third photo-receiver group 117 is divided into four regions of third photo-receiver regions 117a, 117b, 117c and 117d along the Y-axis direction. It is noted that the light emitting point L1 of the second semiconductor laser device 113 and the light emitting point L2 of the third semiconductor laser device 114 are disposed between the second photo-receiver group 116 and the third photo-receiver group 117.

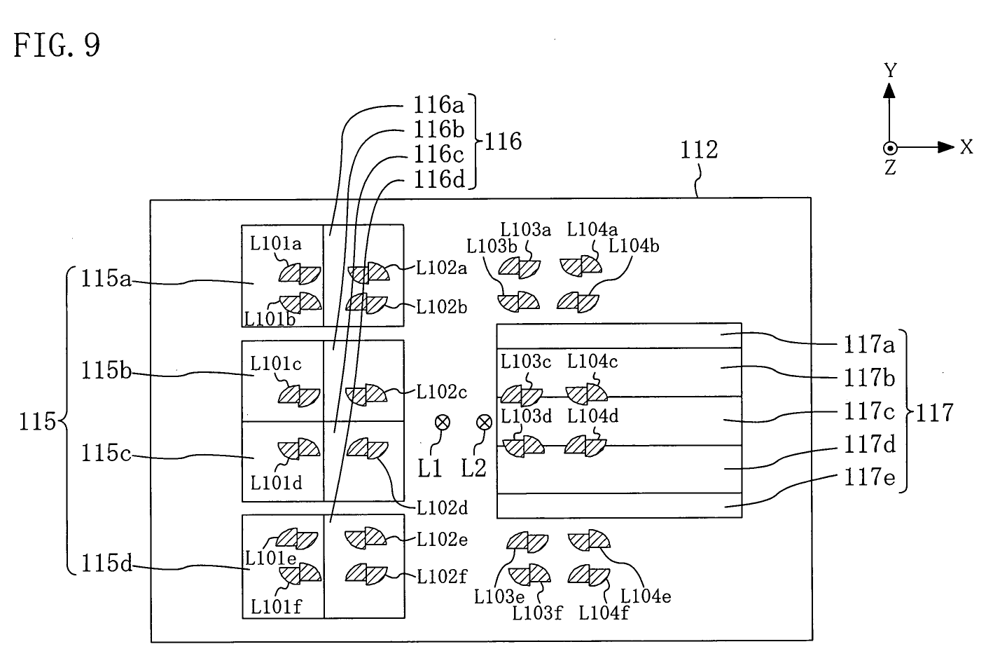

FIG. 9 is a top view for showing diffraction spots obtained on the photo-receiver groups by the first outgoing light 118 in the optical pickup device of this embodiment. As shown in FIG. 9, the ±first-order diffracted light of the first outgoing light 118 composed of the main beam and the sub beam is collected onto the respective divided photo-receiver regions. The diffraction spots L101c and L104d of the main beam of the first outgoing light 118 having been diffracted in the first region 121 (see FIG. 5) are collected respectively on the first photo-receiver region 115b and on the boundary between the third photo-receiver regions 117c and 117d adjacent to each other. The diffraction spots L101a and L101e of the sub beam of the first outgoing light 118 having been diffracted in the first region 121 (see FIG. 5) are collected respectively on the first photo-receiver regions 115a and 115d. The diffraction spots L104b and L104f of the sub beam of the first outgoing light 118 having been diffracted in the first region 121 (see FIG. 5) are collected respectively on a region away from the third photo-receiver region 117a along the Y-axis positive direction (hereinafter referred to as the region A) and on a region away from the third photo-receiver region 117e along the Y-axis negative direction (hereinafter referred to as the region B). It is noted that the regions A and B are not photo-receiver regions but are provided on the integrated substrate 112 as dummy photo-receiver devices or dummy photo-receiver circuits.

Also, the diffraction spots L101d and L104c of the main beam of the first outgoing light 118 having been diffracted in the second region 122 (see FIG. 5) are collected respectively on the first photo-receiver region 115d and on the boundary between the third photo-receiver regions 117b and 117c adjacent to each other. The diffraction spots L101b and L101f of the sub beam of the first outgoing light 118 having been diffracted in the second region 122 (see FIG. 5) are collected respectively on the first photo-receiver regions 115a and 115d. The diffraction spots L104a and L104e of the sub beam of the first outgoing light 118 having been diffracted in the second region 122 (see FIG. 5) are collected respectively on the region A and the region B.

Furthermore, the diffraction spots L102d and L103c of the main beam of the first outgoing light 118 having been diffracted in the third region 123 (see FIG. 5) are collected respectively on the second photo-receiver region 116c and on the boundary between the third photo-receiver regions 117b and 117c adjacent to each other. The diffraction spots L102b and L102f of the sub beam of the first outgoing light 118 having been diffracted in the third region 123 (see FIG. 5) are collected respectively on the second photo-receiver regions 116a and 116d. The diffraction spots L103a and L103e of the sub beam of the first outgoing light 118 having been diffracted in the third region 123 (see FIG. 5) are collected respectively on the region A and the region B.

Also, the diffraction spots L102c and L103d of the main beam of the first outgoing light 118 having been diffracted in the fourth region 124 (see FIG. 5) are collected respectively on the second photo-receiver region 116b and on the boundary between the third photo-receiver regions 117c and 117d adjacent to each other. The diffraction spots L102a and L102e of the sub beam of the first outgoing light 118 having been diffracted in the fourth region 124 (see FIG. 5) are collected respectively on the second photo-receiver regions 116a and 116d. The diffraction spots L103b and L103f of the sub beam of the first outgoing light 118 having been diffracted in the fourth region 124 (see FIG. 5) are collected respectively on the region A and the region B.

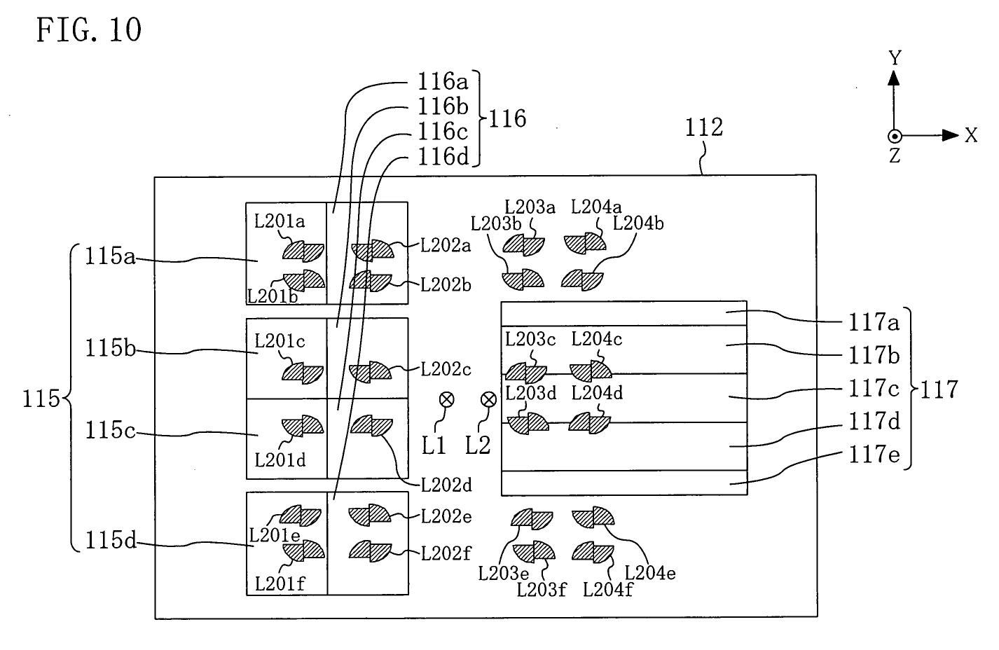

Next, diffraction spots of the ±first-order diffracted light of the second outgoing light 119 collected on the respective photo-receiver groups will be described. FIG. 10 is a top view for showing diffraction spots obtained on the photo-receiver groups by the second outgoing light 119 in the optical pickup device of this embodiment.

As shown in FIG. 10, the ±first-order diffracted light of the second outgoing light 119 composed of the main beam and the sub beam is collected onto the respective divided photo-receiver regions in the same manner as the ±first-order diffracted light of the first outgoing light 118. The diffraction spots L201c and L204d of the main beam of the second outgoing light 119 having been diffracted in the fifth region 125 (see FIG. 6) are collected respectively on the first photo-receiver region 115b and on the boundary between the third photo-receiver regions 117c and 117d adjacent to each other. The diffraction spots L201a and L201e of the sub beam of the second outgoing light 119 having been diffracted in the fifth region 125 (see FIG. 6) are collected respectively on the first photo-receiver regions 115a and 115d. The diffraction spots L204b and L204f of the sub beam of the second outgoing light 119 having been diffracted in the fifth region 125 (see FIG. 6) are collected respectively on the region A and the region B.

Also, the diffraction spots L201d and L204c of the main beam of the second outgoing light 119 having been diffracted in the sixth region 126 (see FIG. 6) are collected respectively on the first photo-receiver region 115d and on the boundary between the third photo-receiver regions 117b and 117c adjacent to each other. The diffraction spots L201b and L201f of the sub beam of the second outgoing light 119 having been diffracted in the sixth region 126 (see FIG. 6) are collected respectively on the first photo-receiver regions 115a and 115d. The diffraction spots L204a and L204e of the sub beam of the second outgoing light 119 having been diffracted in the sixth region 126 (see FIG. 6) are collected respectively on the region A and the region B.

Furthermore, the diffraction spots L202d and L203c of the main beam of the second outgoing light 119 having been diffracted in the seventh region 127 (see FIG. 6) are collected respectively on the second photo-receiver region 116c and on the boundary between the third photo-receiver regions 117b and 117c adjacent to each other. The diffraction spots L202b and L202f of the sub beam of the second outgoing light 119 having been diffracted in the seventh region 127 (see FIG. 6) are collected respectively on the second photo-receiver regions 116a and 116d. The diffraction spots L203a and L203e of the sub beam of the second outgoing light 119 having been diffracted in the seventh region 127 (see FIG. 6) are collected respectively on the region A and the region B.

Also, the diffraction spots L202c and L203d of the main beam of the second outgoing light 119 having been diffracted in the eighth region 128 (see FIG. 6) are collected respectively on the second photo-receiver region 116b and on the boundary between the third photo-receiver regions 117c and 117d adjacent to each other. The diffraction spots L202a and L202e of the sub beam of the second outgoing light 119 having been diffracted in the eighth region 128 (see FIG. 6) are collected respectively on the second photo-receiver regions 116a and 116d. The diffraction spots L203b and L203f of the sub beam of the second outgoing light 119 having been diffracted in the eighth region 128 (see FIG. 6) are collected respectively on the region A and the region B.

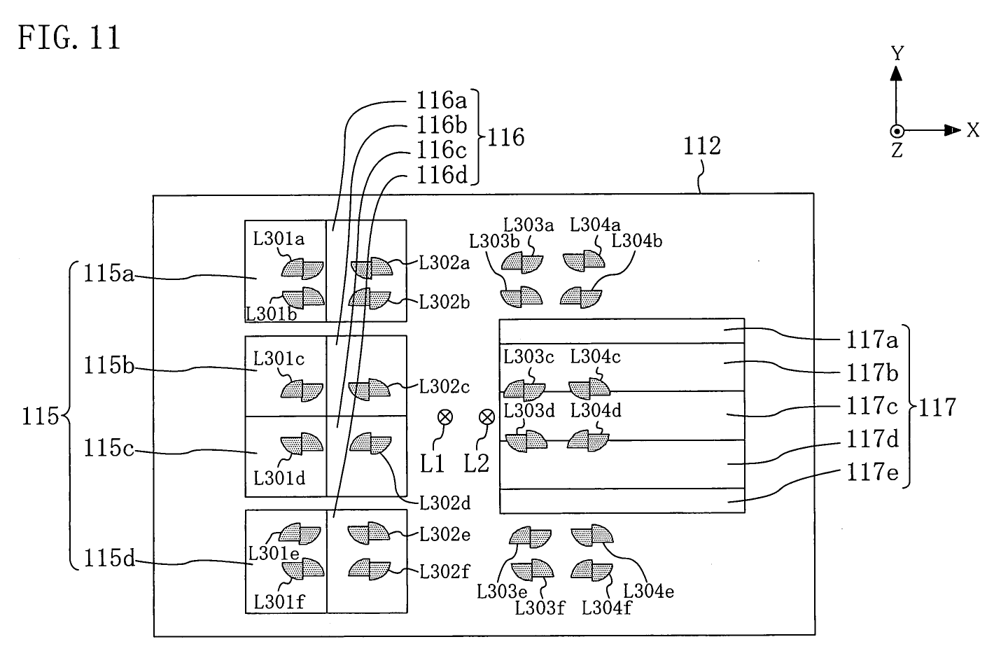

Next, diffraction spots of the ±first-order diffracted light of the third outgoing light 120 collected on the respective photo-receiver groups will be described. FIG. 11 is a top view for showing diffraction spots obtained on the photo-receiver groups by the third outgoing light 120 in the optical pickup device of this embodiment.

As shown in FIG. 11, in the same manner as the ±first-order diffracted light of the first outgoing light 118, the ±first-order diffracted light of the third outgoing light 120 composed of the main beam and the sub beam is collected onto the respective divided photo-receiver regions. The diffraction spots L301c and L304d of the main beam of the third outgoing light 120 having been diffracted in the ninth region 129 (see FIG. 7) are collected respectively on the first photo-receiver region 115b and on the boundary between the third photo-receiver regions 117c and 117d adjacent to each other. The diffraction spots L301a and L301e of the sub beam of the third outgoing light 120 having been diffracted in the ninth region 129 (see FIG. 7) are collected respectively on the first photo-receiver regions 115a and 115d. The diffraction spots L304b and L304f of the sub beam of the third outgoing light 120 having been diffracted in the ninth region 129 (see FIG. 7) are collected respectively on the region A and the region B.

Also, the diffraction spots L301d and L304c of the main beam of the third outgoing light 120 having been diffracted in the tenth region 130 (see FIG. 7) are collected respectively on the first photo-receiver region 115d and on the boundary between the third photo-receiver regions 117b and 117c adjacent to each other. The diffraction spots L301b and L301f of the sub beam of the third outgoing light 120 having been diffracted in the tenth region 130 (see FIG. 7) are collected respectively on the first photo-receiver regions 115a and 115d. The diffraction spots L304a and L304e of the sub beam of the third outgoing light 120 having been diffracted in the tenth region 130 (see FIG. 7) are collected respectively on the region A and the region B.

Furthermore, the diffraction spots L302d and L303c of the main beam of the third outgoing light 120 having been diffracted in the eleventh region 131 (see FIG. 7) are collected respectively on the second photo-receiver region 116c and on the boundary between the third photo-receiver regions 117b and 117c adjacent to each other. The diffraction spots L302b and L302f of the sub beam of the third outgoing light 120 having been diffracted in the eleventh region 131 (see FIG. 7) are collected respectively on the second photo-receiver regions 116a and 116d. The diffraction spots L303a and L303e of the sub beam of the third outgoing light 120 having been diffracted in the eleventh region 131 (see FIG. 7) are collected respectively on the region A and the region B.

Also, the diffraction spots L302c and L303d of the main beam of the third outgoing light 120 having been diffracted in the twelfth region 132 (see FIG. 7) are collected respectively on the second photo-receiver region 116b and on the boundary between the third photo-receiver regions 117c and 117d adjacent to each other. The diffraction spots L302a and L302e of the sub beam of the third outgoing light 120 having been diffracted in the twelfth region 132 (see FIG. 7) are collected respectively on the second photo-receiver regions 116a and 116d. The diffraction spots L303b and L303f of the sub beam of the third outgoing light 120 having been diffracted in the twelfth region 132 (see FIG. 7) are collected respectively on the region A and the region B.

In this manner, the main beams and the sub beams of the ±first-order diffracted light of the respective semiconductor laser devices enter the respective regions of the photo-receiver groups as shown in FIGS. 9 through 11. In the optical pickup device of this embodiment, a signal output from each photo-receiver group is detected by, for example, an operating section provided on the integrated substrate, so as to generate a focus error signal or a tracking error signal on the basis of the detection.

Next, specific analysis methods for a focus error signal and a tracking error signal employed in the optical pickup device of this embodiment will be described.

In the optical pickup device of this embodiment, the known SSD (spot size detection) method is employed for detecting a focus error signal. In the SSD method, the ±first-order diffracted light of the main beam of each semiconductor laser device collected on the third photo-receiver group 117 is used. Herein, it is assumed that a sum of output signals from the third photo-receiver regions 117b and 117d is indicated by F1 and that a sum of output signals from the third photo-receiver regions 117a, 117c and 117e is indicated by F2. In this case, a focus error signal FE1 of the outgoing light of each semiconductor laser device is obtained by the following formula 1:

FE1=F1−F2 Formula 1

Also, the known DPD (differential phase detection) method or DPP (differential push-pull detection) method is appropriately selected in accordance with the loaded optical information recording medium to be employed for detecting a tracking error signal. In the DPD method, the ±first-order diffracted light of the main beam of each semiconductor laser device collected on the first photo-receiver group 115 and the second photo-receiver group 116 is used. On the other hand, in the DPP method, the ±first-order diffracted light of the main beam and the sub beam of each semiconductor laser device collected on the first photo-receiver group 115 and the second photo-receiver group 116 is used.

It is assumed that output signals from the first photo-receiver regions 115b and 115c are indicated by T1 and T2, respectively, that output signals from the second photo-receiver regions 116c and 116b are indicated by T3 and T4, respectively, that a sum of output signals from the first photo-receiver regions 115a and 115d is indicated by T5 and that a sum of output signals from the second photo-receiver regions 116a and 116d is indicated by T6. In this case, a tracking error signal TE(DPD) of the outgoing light of each semiconductor laser device based on the DPD method is obtained by the following formula 2:

TE(DPD)=(phase comparison between T1 and T4)+(phase comparison between T2 and T3) Formula 2

Alternatively, a tracking error signal TE(DPP) of the outgoing light of each semiconductor laser device based on the DPP method is obtained by the following formula 3:

TE(DPP)=(T1+T2)−(T3+T4)−k(T5−T6) Formula 3

wherein k is an arbitrary value.

In the optical pickup device of this embodiment, a focus error signal and a tracking error signal can be analyzed by these detection methods, so as to perform the focus adjustment and the tracking adjustment.

—Effects of Optical Pickup Device—

The optical pickup device of this embodiment includes the three semiconductor laser devices respectively in accordance with the standards of a Blu-ray disc, a DVD and a CD, and the two semiconductor laser devices out of the three semiconductor laser devices and the photo-receiver groups are provided in one light source/detection unit 107. Therefore, as compared with the conventional optical pickup device in which the light source/detection units are provided correspondingly to the wavelengths, the number of components can be reduced. Also, the collimator lens 103, the quarter-wave plate 106, the object lens (not shown), the beam splitter 102 and the photo-receiver groups are shared by all the semiconductor laser devices, the number of components can be further reduced. As a result, the present optical pickup device can cope with the standards of the three different kinds of optical information recording media, and thus, can attain compactness.

Furthermore, in the optical pickup device of this embodiment, the light source/detection unit 107 includes the second diffraction grating 111 and the integrated substrate 112 and can be easily assembled.

Moreover, in the optical pickup device of this embodiment, the first semiconductor laser device 104 is provided outside the light source/detection unit 107, and hence, the first outgoing light 118 can be collected on an optical information recording medium without passing through a polarization hologram device. Therefore, energy loss of the laser beam otherwise caused in passing through a polarization hologram device can be suppressed. Thus, an optical pickup device with high optical utilization capable of high speed recording can be realized.

In the optical pickup device of this embodiment, the first semiconductor laser device 104 for emitting laser beams of the shortest wavelength is preferably provided outside the light source/detection unit 107. In general, a laser beam of a shorter wavelength loses larger energy in passing through a polarization hologram device. Accordingly, the outgoing light of the semiconductor laser device can be more effectively used by providing the first semiconductor laser device 104 outside.

In the optical pickup device of this embodiment, the principal ray of the first outgoing light 118 and the principal ray of the second outgoing light 119 obtained on the collimator lens 103 preferably accord with the optical axis of the collimator lens 103. Thus, each of the outgoing light of the first semiconductor laser device 104 and the second semiconductor laser device 113 enters the object lens in an optimum position at an optimum angle so as to improve the quality of each beam spot shape obtained on an optical information recording medium. Therefore, a Blu-ray disc and a DVD can be accurately recorded/reproduced. As a result, a high performance optical pickup device capable of coping with the standards of the various optical information recording media can be realized.

Furthermore, in the optical pickup device of this embodiment, the third polarization hologram device may be replaced with a non-polarization hologram device. Thus, even when an optical information recording medium corresponding to the wavelength of the third outgoing light 120 has poor quality, a writing operation can be stably performed.

The first semiconductor laser device 104 is disposed so that the principal ray of the first outgoing light 118 can be perpendicular to the optical axis of the collimator lens 103 in the optical pickup device of this embodiment, which does not limit the invention.

Also, the quarter-wave plate 106 is disposed between the beam splitter 102 and the collimator lens 103 in the optical pickup device of this embodiment, which does not limit the invention. Instead, the quarter-wave plate 106 may be disposed between the collimator lens 103 and the object lens on the optical paths of the first outgoing light 118, the second outgoing light 119 and the third outgoing light 120. Even in this case, the aforementioned effects can be attained.

The object lens provided in the optical pickup device of this embodiment may be one lens or a combined lens composed of a plurality of lenses. Furthermore, an object lens for the first semiconductor laser device and an object lens for the second and third semiconductor laser devices may be separately provided. In either case, the aforementioned effects can be attained.

A Blu-ray disc is described as one kind of optical information recording media to be loaded in the optical pickup device of this embodiment, which does not limit the invention. The aforementioned effects can be similarly attained even in using an HD DVD. Moreover, the optical pickup device of this embodiment is applicable to all kinds of optical information recording media having standards corresponding to semiconductor laser of a 405 nm band.

### Embodiment 2

The architecture and the operation of an optical pickup device according to Embodiment 2 of the invention will now be described with reference to the accompanying drawings. In the optical pickup device of this embodiment, a collimator lens is provided in a position different from that in the optical pickup device of Embodiment 1 described above.

—Architecture of Optical Pickup Device—

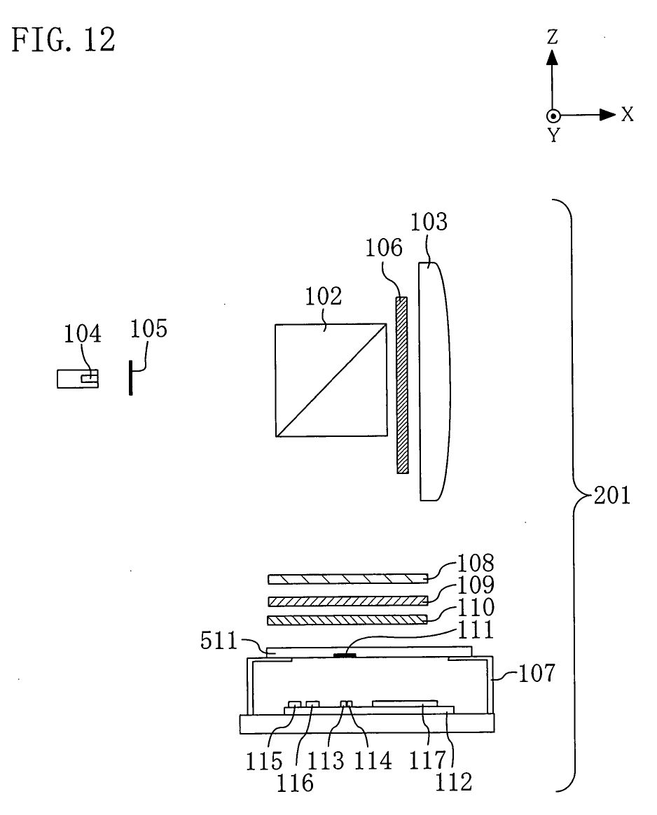

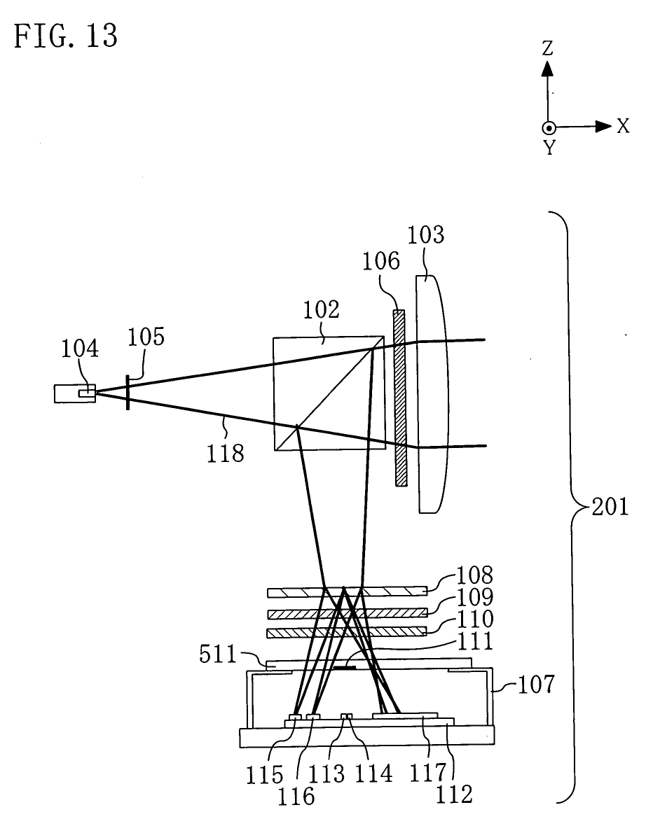

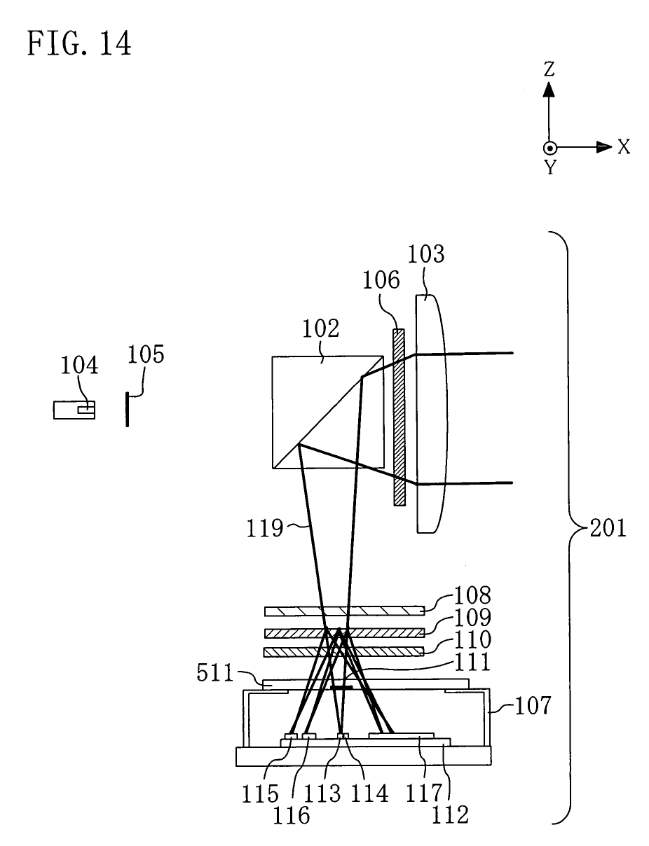

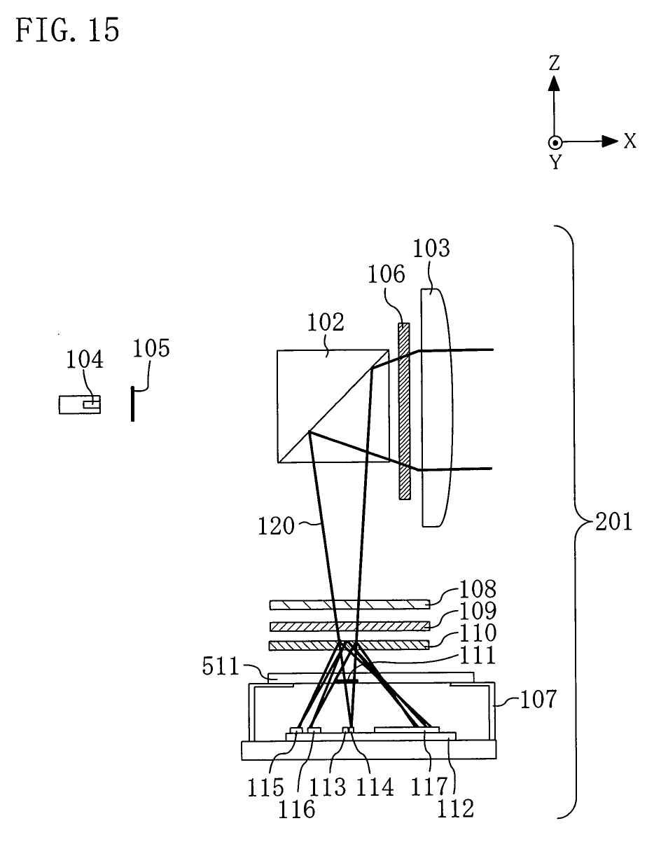

FIG. 12 is a cross-sectional view for showing the architecture of the optical pickup device of Embodiment 2 of the invention. As shown in FIG. 12, the optical pickup device of this embodiment includes three semiconductor laser devices for coping with three kinds of optical information recording media. A first semiconductor laser device 104 emits laser beams of a 405 nm band in accordance with the Blu-ray disc standard (first outgoing light 118 shown in FIG. 13). Also, a second semiconductor laser device 113 emits laser beams of a 650 nm band in accordance with the DVD standard (second outgoing light 119 shown in FIG. 14), and a third semiconductor laser device 114 emits laser beams of a 780 nm band in accordance with the CD standard (third outgoing light 120 shown in FIG. 15).

The optical pickup device 201 of this embodiment includes the first semiconductor laser device 104, a first diffraction grating 105, a beam splitter 102, a quarter-wave plate 106, a collimator lens 103, a light source/detection unit 107, and a first polarization hologram device 108, a second polarization hologram device 109 and a third polarization hologram device 110 arranged between the light source/detection unit 107 and the beam splitter 102 in this order from a side of the beam splitter 102. The first diffraction grating 105 is disposed between the first semiconductor laser device 104 and the beam splitter 102. The quarter-wave plate 106 is disposed between the beam splitter 102 and the collimator lens 103.

The light source/detection unit 107 includes an integrated substrate 112, the second semiconductor laser device 113, the third semiconductor laser device 114, a first photo-receiver group 115, a second photo-receiver group 116, a third photo-receiver group 117 and a second diffraction grating 111. At this point, the second diffraction grating 111 is formed on the lower face of a transparent member 511 made of a glass plate or the like to be positioned above the second semiconductor laser device 113 and the third semiconductor laser device 114.

In the optical pickup device of this embodiment, the positional relationship among the first semiconductor laser device 104, the light source/detection unit 107 and the collimator lens 103 is different from that in the optical pickup device of Embodiment 1. Specifically, in the optical pickup device of this embodiment, the collimator lens 103 is disposed so that the optical axis of the collimator lens 103 can be perpendicular to the principal ray of the second outgoing light 119 and the principal ray of the third outgoing light 120. The second outgoing light 119 and the third outgoing light 120 pass through the second diffraction grating 111 and enter the beam splitter 102. The second outgoing light 119 and the third outgoing light 120 are then reflected by the beam splitter 102, and the reflected light is guided to the collimator lens 103.

On the other hand, the first outgoing light 118 passes through the beam splitter 102. Also, reflected light from an optical information recording medium passes through the beam splitter 102 and is guided to the first polarization hologram device 108, the second polarization hologram device 109 and the third polarization hologram device 110.

At this point, the first polarization hologram device 108 is designed so as to diffract the first outgoing light 118 and to transmit the second outgoing light 119 and the third outgoing light 120. Similarly, the second polarization hologram device 109 diffracts the second outgoing light 119 alone, and the third polarization hologram device 110 diffracts the third outgoing light 120 alone.

—Operation of Optical Pickup Device—

The operation of the optical pickup device 201 of this embodiment will now be described with reference to FIGS. 13 through 15. Also in the optical pickup device 201 of this embodiment, after discriminating the standard of a loaded optical information recording medium, one of the semiconductor laser devices in accordance with the standard is used to irradiate the optical information recording medium with laser beams.

FIG. 13 is a cross-sectional view of the optical path of the first outgoing light 118 in the optical pickup device of this embodiment.

As shown in FIG. 13, the first outgoing light 118 is diffracted by the first diffraction grating 105 into a main beam and a sub beam. The diffracted first outgoing light 118 passes through the beam splitter 102, passes through the quarter-wave plate 106 and is collimated by the collimator lens 103. Thereafter, the first outgoing light 118 is collected by an object lens (not shown) onto a recording surface of the optical information recording medium. The first outgoing light 118 having been reflected on the recording surface is reflected by the beam splitter 102 and enters the first polarization hologram device 108. Then, the first outgoing light 118 is diffracted by the first polarization hologram device 108 into ±first-order diffracted light and then passes through the second polarization hologram device 109 and the third polarization hologram device 110. Thereafter, the first outgoing light 118 enters the first photo-receiver group 115, the second photo-receiver group 116 and the third photo-receiver group 117.

FIG. 14 is a cross-sectional view of the optical path of the second outgoing light 119 in the optical pickup device of this embodiment.

As shown in FIG. 14, the second outgoing light 119 is diffracted by the second diffraction grating 111 into a main beam and a sub beam. The diffracted second outgoing light 119 is reflected by the beam splitter 102, passes through the quarter-wave plate 106 and is collimated by the collimator lens 103. Thereafter, the second outgoing light 119 is collected by an object lens (not shown) onto a recording surface of the optical information recording medium. The second outgoing light 119 having been reflected on the recording surface is reflected by the beam splitter 102 through the same optical path as the outward path, passes through the first polarization hologram 108 and enters the second polarization hologram device 109. Then, the second outgoing light 119 is diffracted by the second polarization hologram device 109 into ±first-order diffracted light and then passes through the third polarization hologram device 110. Thereafter, the second outgoing light 119 enters the first photo-receiver group 115, the second photo-receiver group 116 and the third photo-receiver group 117.

FIG. 15 is a cross-sectional view of the optical path of the third outgoing light 120 in the optical pickup device of this embodiment.

As shown in FIG. 15, the third outgoing light 120 is diffracted by the second diffraction grating 111 into a main beam and a sub beam in the same manner as the second outgoing light 119. The diffracted third outgoing light 120 is vertically reflected by the beam splitter 102, passes through the quarter-wave plate 106 and is collimated by the collimator lens 103. Thereafter, the third outgoing light 120 is collected by an object lens (not shown) onto a recording surface of the optical information recording medium. The third outgoing light 120 having been reflected on the recording surface is reflected by the beam splitter 102 through the same optical path as the outward path, passes through the first polarization hologram device 108 and the second polarization hologram device 109 and enters the third polarization hologram device 110. Then, the third outgoing light 120 is diffracted by the third polarization hologram device 110 into ±first-order diffracted light and enters the first photo-receiver group 115, the second photo-receiver group 116 and the third photo-receiver group 117.

In this manner, the outgoing light of each semiconductor laser device is reflected on the recording surface of the optical information recording medium, diffracted into the ±first-order diffracted light by the polarization hologram device corresponding to the wavelength, and then enters the respective photo-receiver groups. In each of the photo-receiver groups, the incident light is processed to be converted into a tracking error signal, a focus error signal and information data. Thus, information can be recorded/reproduced in/from the optical information recording medium.

—Effects of Optical Pickup Device—

The optical pickup device of this embodiment includes the three semiconductor laser devices respectively in accordance with the standards of a Blu-ray disc, a DVD and a CD, and the two semiconductor laser devices out of the three semiconductor laser devices and the photo-receiver groups are provided in one light source/detection unit 107 in the same manner as in Embodiment 1. Also, the collimator lens 103, the quarter-wave plate 106, the object lens (not shown), the beam splitter 102 and the photo-receiver groups are shared by all the semiconductor laser devices in the optical pickup device of this embodiment. Furthermore, the light source/detection unit 107 includes the second diffraction grating 111 and the integrated substrate 112. As a result, the present optical pickup device can cope with the standards of the three different kinds of optical information recording media, and thus, a compact optical pickup device easily assembled can be realized.

Moreover, in the optical pickup device of this embodiment, the first semiconductor laser device 104 for emitting the laser beams of the shortest wavelength is preferably provided outside the light source/detection unit 107. Thus, energy loss of the laser beams otherwise caused in passing through a polarization hologram device can be suppressed, and hence, the outgoing light of the semiconductor laser device can be more effectively used.

In the optical pickup device of this embodiment, the principal ray of the first outgoing light 118 and the principal ray of the second outgoing light 119 obtained on the collimator lens 103 preferably accord with the optical axis of the collimator lens 103. Thus, each of the outgoing light of the first semiconductor laser device 104 and the second semiconductor laser device 113 enters the object lens in an optimum position at an optimum angle so as to improve the quality of each beam spot shape obtained on an optical information recording medium. Therefore, a Blu-ray disc and a DVD can be accurately recorded/reproduced. As a result, a high performance optical pickup device capable of coping with the standards of the various optical information recording media can be realized.

Furthermore, in the optical pickup device of this embodiment, the third polarization hologram device may be replaced with a non-polarization hologram device. Thus, even when an optical information recording medium corresponding to the wavelength of the third outgoing light 120 has poor quality, a writing operation can be stably performed.

The second semiconductor laser device 113 and the third semiconductor laser device 114 are disposed so that the principal rays of the second outgoing light 119 and the third outgoing light 120 can be perpendicular to the optical axis of the collimator lens 103 in the optical pickup device of this embodiment, which does not limit the invention.

### Embodiment 3

The architecture and the operation of an optical pickup device according to Embodiment 3 of the invention will now be described with reference to the accompanying drawings. The optical pickup device of this embodiment includes semiconductor laser devices having different structures from those of the optical pickup device according to Embodiment 1 described above.

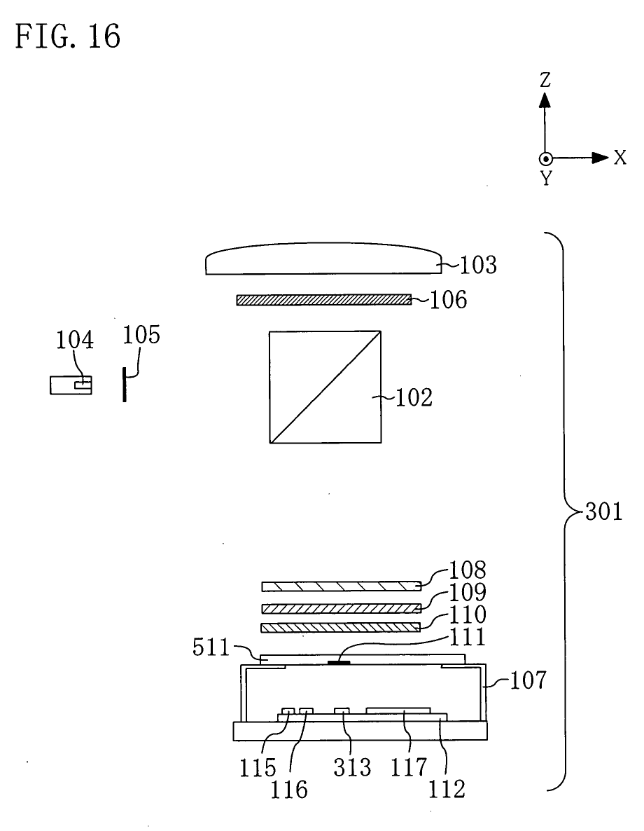

FIG. 16 is a cross-sectional view for showing the architecture of the optical pickup device according to Embodiment 3 of the invention. As shown in FIG. 16, the optical pickup device 301 of this embodiment includes a first semiconductor laser device 104 and a fourth semiconductor laser device 313 made of a monolithic dual-wavelength semiconductor laser device for coping with three kinds of optical information recording media.

The optical pickup device 301 of this embodiment includes the first semiconductor laser device 104, a first diffraction grating 105, a beam splitter 102, a quarter-wave plate 106, a collimator lens 103, a light source/detection unit 107, and a first polarization hologram device 108, a second polarization hologram device 109 and a third polarization hologram device 110 arranged between the light source/detection unit 107 and the beam splitter 102 in this order from a side of the beam splitter 102.

The light source/detection unit 107 includes an integrated substrate 112, the fourth semiconductor laser device 313, a first photo-receiver group 115, a second photo-receiver group 116, a third photo-receiver group 117 and a second diffraction grating 111. At this point, the second diffraction grating 111 is formed on the lower face of a transparent member 511 made of a glass plate or the like so as to be positioned above the fourth semiconductor laser device 313.

The optical pickup device of this embodiment having the aforementioned architecture can record/reproduce information in/from each kind of optical information recording media through an operation similar to that of the optical pickup device of Embodiment 1.

As characteristics of the optical pickup device of this embodiment, the fourth semiconductor laser device 313 is made of a monolithic dual-wavelength semiconductor laser device for emitting a laser beam of a 650 nm band and a laser beam of a 780 nm band, and the fourth semiconductor laser device 313 and the photo-receiver groups are provided in one light source/detection unit 107. Thus, one semiconductor laser device can cope with two kinds of optical information recording media, and hence, the number of components can be reduced. Also, the collimator lens 103, the quarter-wave plate 106, an object lens (not shown), the beam splitter 102 and the photo-receiver groups are shared by all the semiconductor laser devices in the optical pickup device of this embodiment. Furthermore, the light source/detection unit 107 includes the second diffraction grating 111 and the integrated substrate 112. As a result, the present optical pickup device can cope with the standards of the three different kinds of optical information recording media, and thus, a compact optical pickup device easily assembled can be realized.

Moreover, since the monolithic dual-wavelength semiconductor laser device is used, a distance between semiconductor laser devices provided adjacently on a substrate, namely, what is called an optical beam emitting distance, can be improved in the accuracy. In general, in the case where a monolithic dual-wavelength semiconductor laser device is not used, namely, in the case where two kinds of semiconductor laser devices are used, the accuracy in the optical beam emitting distance depends upon the assembling accuracy. In this case, if two kinds of semiconductor laser devices are individually mounted on an integrated substrate, the optical beam emitting distance may largely varied by approximately 10 μm. On the other hand, in the case where a monolithic dual-wavelength semiconductor laser device is used, the accuracy in the optical beam emitting distance depends upon diffusion accuracy. At this point, the diffusion accuracy means the accuracy of a diffusion mask used in forming the semiconductor laser device on a substrate. In this case, the variation in the optical beam emitting distance can be suppressed to approximately 1 μm or less by forming a monolithic dual-wavelength semiconductor laser device on a substrate by using a diffusion mask. Accordingly, higher accuracy in the optical beam emitting distance can be attained by using a monolithic dual-wavelength semiconductor laser device. As a result, the laser beam of the fourth semiconductor laser device 313 made of a monolithic dual-wavelength semiconductor laser device can be more accurately emitted, so as to improve the accuracy in recording/reproducing information in/from an optical information recording medium having the standard corresponding to the wavelength of the laser beam.

Furthermore, in the optical pickup device of this embodiment, the third polarization hologram device may be replaced with a non-polarization hologram device. Thus, even when an optical information recording medium corresponding to the wavelength of third outgoing light 120 has poor quality, a writing operation can be stably performed.

Also the optical pickup device of this embodiment attains the same effects as those attained by the optical pickup device of Embodiment 1.

In the optical pickup device of this embodiment, the second semiconductor laser device and the third semiconductor laser device used in the optical pickup device of Embodiment 1 are replaced with the monolithic dual-wavelength semiconductor laser device, which does not limit the invention. For example, a monolithic dual-wavelength semiconductor laser device may be used in the optical pickup device according to Embodiment 2 of the invention.

The monolithic dual-wavelength semiconductor laser device emits the laser beam of the 650 nm band the laser beam of the 780 nm band in this embodiment, which does not limit the invention. The monolithic dual-wavelength semiconductor laser device may emit a laser beam of a 405 nm band a laser beam of a 650 nm band, or a laser beam of a 405 nm band and a laser beam of a 780 nm band.

### Embodiment 4

The architecture and the operation of an optical pickup device according to Embodiment 4 of the invention will now be described with reference to the accompanying drawing. The optical pickup device of this embodiment includes a polarization hologram device having a different structure from that of the optical pickup device of Embodiment 1 described above.

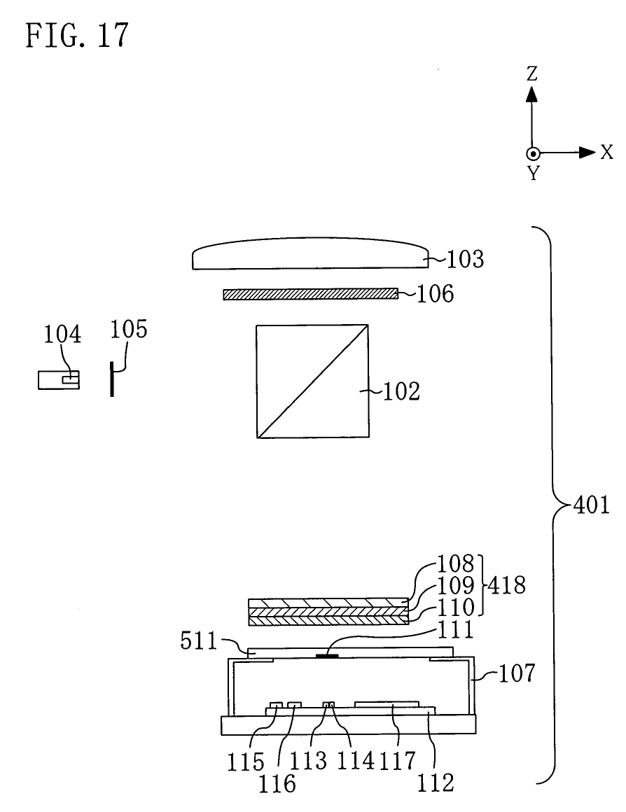

FIG. 17 is a cross-sectional view for showing the architecture of the optical pickup device according to Embodiment 4 of the invention. As shown in FIG. 17, the optical pickup device 401 of this embodiment includes three semiconductor laser devices for coping with three kinds of optical information recording media.

The optical pickup device 401 of this embodiment includes a first semiconductor laser device 104, a beam splitter 102, a quarter-wave plate 106, a collimator lens 103, a light source/detection unit 107, and a fourth polarization hologram device 418 disposed between the light source/detection unit 107 and the beam splitter 102.

The fourth polarization hologram device 418 is composed of a first polarization hologram device 108, a second polarization hologram device 109 and a third polarization hologram device 110 arranged in this order from a side of the beam splitter 102. The polarization hologram devices in contact with each other are adhered to each other with, for example, an adhesive.

Furthermore, the light source/detection unit 107 includes an integrated substrate 112, a second semiconductor laser device 113, a third semiconductor laser device 114, a first photo-receiver group 115, a second photo-receiver group 116, a third photo-receiver group 117 and a second diffraction grating 111. At this point, the second diffraction grating 111 is formed on the lower face of a transparent member 511 made of a glass plate or the like so as to be positioned above the second semiconductor laser device 113 and the third semiconductor laser device 114.

The optical pickup device of this embodiment having the aforementioned architecture can record/reproduce information in/from each kind of optical information recording media through a similar operation to that of the optical pickup device of Embodiment 1 described above.

The optical pickup device of this embodiment is characterized by the fourth polarization hologram device of the integrated type composed of the first polarization hologram device 108, the second polarization hologram device 109 and the third polarization hologram device 110. Since the polarization hologram device of the integrated type is used, the assembling accuracy for the polarization hologram devices can be improved as compared with the case where the respective polarization hologram devices are individually provided. As a result, a compact optical pickup device easily assembled can be realized.

Furthermore, in the optical pickup device of this embodiment, the third polarization hologram device may be replaced with a non-polarization hologram device. Thus, even when an optical information recording medium corresponding to the wavelength of third outgoing light 120 has poor quality, a writing operation can be stably performed.

The optical pickup device of this embodiment also attains the same effects as those attained by the optical pickup device of Embodiment 1 described above.

The respective polarization hologram devices used in the optical pickup device of Embodiment 1 are replaced with the fourth polarization hologram device in the optical pickup device of this embodiment, which does not limit the invention. The polarization hologram device of the integrated type may be used in, for example, the optical pickup device of Embodiment 2 or Embodiment 3.

### Embodiment 5

The architecture and the operation of an optical pickup device according to Embodiment 5 of the invention will now be described with reference to the accompanying drawing. The optical pickup device of this embodiment includes a light source/detection unit and a polarization hologram device having different structures from those used in the optical pickup device of Embodiment 1 described above.

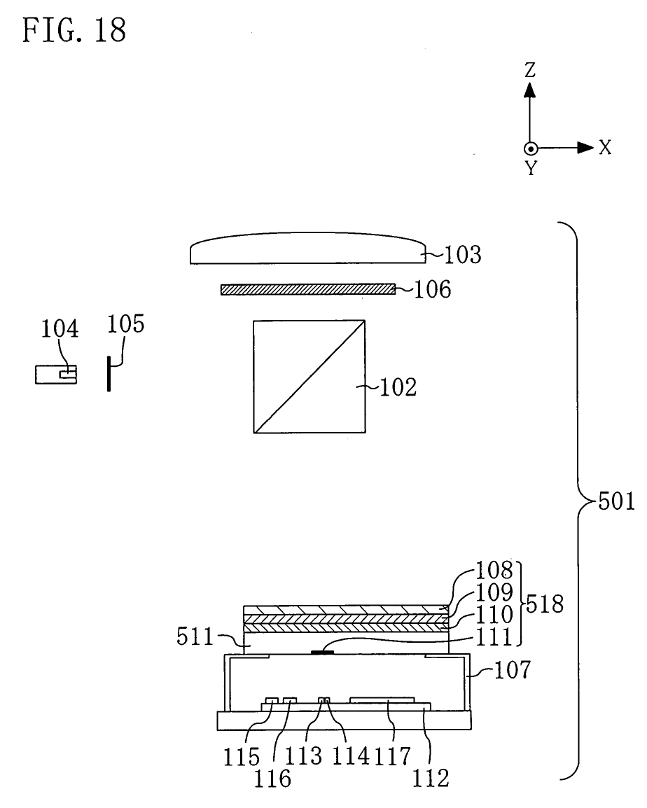

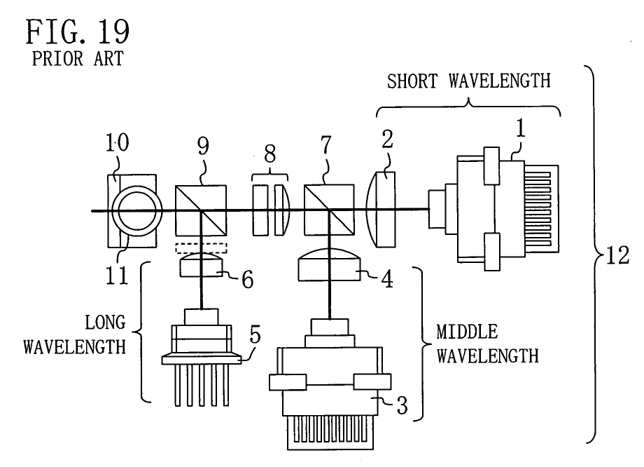

FIG. 18 is a cross-sectional view for showing the architecture of the optical pickup device according to Embodiment 5 of the invention. As shown in FIG. 18, the optical pickup device 501 of this embodiment includes three semiconductor laser devices for coping with three kinds of optical information recording media.

The optical pickup device 501 of this embodiment includes a first semiconductor laser device 104, a beam splitter 102, a quarter-wave plate 106, a collimator lens 103, a light source/detection unit 107 and a diffraction grating-integrated polarization hologram device 518 disposed on the light source/detection unit 107.

The light source/detection unit 107 includes an integrated substrate 112, a second semiconductor laser device 113, a third semiconductor laser device 114, a first photo-receiver group 115, a second photo-receiver group 116 and a third photo-receiver group 117.

The diffraction grating-integrated polarization hologram device 518 includes a first polarization hologram device 108, a second polarization hologram device 109, a third polarization hologram device 110 and a second diffraction grating 111 arranged in this order from a side of the beam splitter 102. At this point, the second diffraction grating 111 is formed on the lower face of a transparent member 511 made of a glass plate or the like so as to be positioned above the second semiconductor laser device 113 and the third semiconductor laser device 114. The polarization hologram devices in contact with each other, the third polarization hologram device 110 and the transparent member 511, and the transparent member 511 and the light source/detection unit 107 are adhered to each other with, for example, an adhesive.

The optical pickup device of this embodiment having the aforementioned architecture can record/reproduce information in/from each kind of optical information recording media through a similar operation to that of the optical pickup device of Embodiment 1 described above.

As characteristics of the optical pickup device of this embodiment, it includes the diffraction grating-integrated polarization hologram device 518 composed of the second diffraction grating and the respective polarization hologram devices, and the diffraction grating-integrated polarization hologram device 518 is integrated with the light source/detection unit 107. Thus, as compared with the case where these components are individually provided, the assembling accuracy for the polarization hologram devices, the second diffraction grating and the light source/detection unit can be improved. As a result, a compact optical pickup device easily assembled can be realized.

In the optical pickup device of this embodiment, the thickness of the transparent member 511 included in the diffraction grating-integrated polarization hologram device 518 is larger than that of the optical pickup device of Embodiment 1. Thus, a distance from each of the polarization hologram devices to the second diffraction grating 111 can be sufficiently secured, and hence, ±first-order diffracted light from each polarization hologram device can be collected onto the photo-receiver groups without passing through the second diffraction grating 111. Thus, the optical pickup device 511 can obtain a stable signal.

Furthermore, in the optical pickup device of this embodiment, the third polarization hologram device may be replaced with a non-polarization hologram device. Thus, even when an optical information recording medium corresponding to the wavelength of third outgoing light 120 has poor quality, a writing operation can be stably performed.

Also the optical pickup device of this embodiment attains the same effects as those attained in the optical pickup device of Embodiment 1 described above.

As described so far, the present invention is useful for an optical pickup device for recording/reproducing information in/from, for example, a Blu-ray disc, a DVD, a CD and the like.

What is claimed is:

1. An optical pickup device comprising:
a first semiconductor laser device for emitting a first light beam;
a second semiconductor laser device for emitting a second light beam;
a third semiconductor laser device for emitting a third light beam;
a collimator lens for collimating said first light beam, said second light beam and said third light beam;
a beam splitter for reflecting or transmitting said first light beam, said second light beam and said third light beam and collecting said first light beam, said second light beam and said third light beam on said collimator lens;
a first hologram device for diffracting, into ±first-order diffracted light, said first light beam having been reflected on a recording surface of an optical information recording medium and having passed through said beam splitter;
a second hologram device for diffracting, into ±first-order diffracted light, said second light beam having been reflected on the recording surface of the optical information recording medium and having passed through said beam splitter;
a third hologram device for diffracting, into ±first-order diffracted light, said third light beam having been reflected on the recording surface of the optical information recording medium and having passed through said beam splitter; and
a plurality of photo-receiver groups for receiving said ±first-order diffracted light having been diffracted by said first hologram device, said second hologram device and said third hologram device,
wherein said second semiconductor laser device, said third semiconductor laser device and said plurality of photo-receiver groups are provided in one light source/detection unit.

2. The optical pickup device of claim 1, further comprising a first diffraction grating, for diffracting said first light beam into a main beam and a sub beam, provided on an optical path of said first light beam extending from said first semiconductor laser device to said beam splitter.

3. The optical pickup device of claim 1, further comprising a second diffraction grating, for diffracting each of said second light beam and said third light beam into a main beam and a sub beam, provided on an optical path of said second light beam extending from said second semiconductor laser device to said beam splitter and on an optical path of said third light beam extending from said third semiconductor laser device to said beam splitter.

4. The optical pickup device of claim 3,
wherein said second diffraction grating is provided on said light source/detection unit to be positioned above said second semiconductor laser device and said third semiconductor laser device.

5. The optical pickup device of claim 3,
wherein said first hologram device, said second hologram device and said third hologram device are provided between said beam splitter and said second diffraction grating.

6. The optical pickup device of claim 5,
wherein said first hologram device, said second hologram device and said third hologram device are integrated with one another.

7. The optical pickup device of claim 6,
wherein said first hologram device, said second hologram device, said third hologram device and said second diffraction grating are integrated with said light source/detection unit.

8. The optical pickup device of claim 1,
wherein there is a relationship of A<B<C among a wavelength A of said first light beam, a wavelength B of said second light beam and a wavelength C of said third light beam.

9. The optical pickup device of claim 8,
wherein said first light beam has a wavelength of a 405 nm band, said second light beam has a wavelength of a 650 nm band and said third light beam has a wavelength of a 780 nm band.

10. The optical pickup device of claim 1,
wherein a principal ray of said first light beam and a principal ray of said second light beam substantially accord with an optical axis of said collimator lens on said collimator lens.

11. The optical pickup device of claim 1,
wherein said second semiconductor laser device and said third semiconductor laser device are integrated with each other as a monolithic dual-wavelength semiconductor laser device.

12. The optical pickup device of claim 1,
wherein said first hologram device transmits said second light beam and said third light beam,
said second hologram device transmits said first light beam and said third light beam, and
said third hologram device transmits said first light beam and said second light beam.

13. The optical pickup device of claim 1,
wherein each of said first hologram device, said second hologram device and said third hologram device is a polarization hologram device.

14. The optical pickup device of claim 1,
wherein each of said first hologram device and said second hologram device is a polarization hologram device, and said third hologram device is a non-polarization hologram device.

15. The optical pickup device of claim 1, further comprising a quarter-wave plate disposed between said beam splitter and said collimator lens.

16. The optical pickup device of claim 1, further comprising:
an object lens for collecting, on the optical information recording medium, said first light beam, said second light beam and said third light beam having been collimated by said collimator lens; and
a quarter-wave plate disposed on an optical path of said first light beam, said second light beam and said third light beam between said collimator lens and said object lens.

17. The optical pickup device of claim 1,
a principal ray of said first light beam substantially accords with an optical axis of said collimator lens.

18. The optical pickup device of claim 1, further comprising an operating section for detecting each electric signal output from said plurality of photo-receiver groups and generating a focus error signal or a tracking error signal based on said detected electric signal.
